(19) United States
(12) Patent Application Publication
(10) Pub. No.: US 2006/0096076 A1
(43) Pub. Date: May 11, 2006

(54) Toll for riveted connection

(76) Inventor: Eugen Rapp, Berg (DE)

Correspondence Address: Orum & Roth, 53 W Jackson Blvd, Chicago, IL, 60604, US

(21) Appl. No.: 10/510,322

(22) PCT Filed: Apr. 4, 2003
(86) PCT No.: PCT/DE03/01127

§ 371 Date: Sep. 22, 2005

(30) Foreign Application Priority Data
Apr. 4, 2002 (DE) 10214957.7
Jul. 12, 2002 (DE) 10231832.8

(51) Int. Cl. B23P 11/00; B21J 15/02

(52) U.S. Cl. 29/525.06; 29/243.53

(57) ABSTRACT

Proposed is a method, as well as a tool, for performing a process to create a joint in which wall sections 8 of work opening 4 of die 5 are designed to yield, and in which cold hardening of the compressed material is achieved by a stop element after a specified distance has been traversed.

### STATE OF THE ART

The invention relates to a method for joining components with at least one plate, according to Claim 1, and one tool, according to Claim 5, in particular for the performance of this method.

In a known method of this type (GB 2069394 A), the wall sections are composed of four columns forming a die, in which the columns absorb the radial elasticity, and between the columns are splits that receive the compressed material and result in an uncontrolled shaping of the material. According to one embodiment, these splits are also provided in the base of the die, whereby the radial flow is hindered during squeezing of the surface pieces. According to another embodiment, the base, at least in its central area, is closed and is formed by a yielding ram, which exhibits the disadvantage whereby the compressed material during radial separation can enter into the formed splits between said columns and this ram.

According to another known method (EP 0330061), two diametrically opposed wall sections are formed such that they yield in a flexing manner, whereby the deep-drawn and compressed surface pieces undercut the plate on the yielding places, whereas in the other transverse directions in which no yielding walls are present, said surface pieces move smoothly in the joining direction. The disadvantage of this method is that, on the one hand, during the process during the separation of the opposing wall sections, compressed material can enter into the splits, and on the other hand, the non-deep-drawn sections can pass conically outward, that is, can tend to come apart. This depends primarily upon obtaining in sections, at least, the greatest possible drawing of the compressed surface sections under the rigid sections of the plate and, secondarily, succeeding with one work step to create such a connecting point with sufficient strength.

Interest was directed primarily toward clearly separating the deep-draw process from the compression process in order to main control over the method. In a known embodiment (DE OS 4435460), the displaced wall sections of the die are loaded not only by one spring against the compression direction, but by a pitching moment is also generated whereby a clear separation occurs between the end of the deep-draw process and the start of the compression process without a resulting direct influence upon the compression process by these movable wall sections.

There is also a known embodiment for a joining procedure in which all four wall sections of a die are radially expressed outwardly against an annular spring during a deep-draw and/or compression process (EP 0653255 A1). A metal cage encloses the die that serves only to accept and guide the die sections. This cage has no influence upon the deep-draw or compression process. The disadvantage of this is that the base of the die forms the end side of a ram that enters into the die, and that the die wall sections are guided to a stage of said ram for the compression process. In addition, it is considered a requirement that on the end side of this ram a known elevation is present that has a resulting influence upon the compression process. When this tool is used, there arises the disadvantage that the radial forces on the upper ends adhere to the wall sections of the die, thus creating a pitching moment that can lead to the guide pins arranged in the cage being bent. In addition, there exists the disadvantage that compressed material can move into the region between the wall sections and this ram, so that the actual compression process becomes largely uncontrollable with regard to material deformation of the plate sections, whereby the elevation on the base of the ram has a disadvantageous effect. It is apparent that the result sought with this tool is a deep undercut on all sides of the connection point.

### THE INVENTION AND ITS ADVANTAGES

The method, according to the invention with the identifying features of the primary claim, as well as the tool, according to the invention with identifying features according to Claims 2, 5, and 12, has the advantage of effecting a controlled smooth deep-draw process in order to achieve an exact radial compression without the compressed material flowing into any gaps. In the non-moving wall sections, the compressed material preferably flows in the direction of the movable wall sections, that is, at this location compressed material from the deep-drawn and plate sections accumulates to ensure that the materials undercutting the plate are firmly attached as a result of the stop element. In each instance, as each part of the wall sections remains in place, a greater undercut of the remaining surface sections is achieved.

According to one preferable embodiment of the invention, the rigid limitation of the path of the yielding wall sections results in cold forming of the compressed material that achieves an increase in strength of the joint by approximately 30 percent compared to non-cold-formed compressed material. In addition to these advantages, such a connecting point may be created in one work step, despite undercutting by means of the corresponding guide of the flow of the compressed material; this means that the workpiece can be removed from the tooling without any additional work steps by the tool.

According to a preferred embodiment of the method, the limit of the radial path seen across the perimeter of the die is variable, changeable, or of different dimensions, the result being that different degrees of hardness may be achieved during cold forming.

According to an additional embodiment of the method according to the invention, that section of the punch entering into the die opening is formed as a rivet-like and form-fit lost punch. This achieves a virtually undetachable press-stud-like joint point while providing the possibility of attaching additional fasteners such as nuts, bolts, and similar elements to the plate since the lost die is shaped like one of these fasteners or the receptacle of such fasteners.

The particular advantage of the tool according to the invention is that along the perimeter of the die opening, between the movable cladding pieces, there are rigid, one-piece fixed parts connected to the base element that provide a simply controlled guide for the yielding cladding pieces. The radially compressed material is thus pressed into the regions of the yielding cladding pieces whereby the subsequent pressing process, due to the stop elements, achieves a correspondingly high compaction and hardness of the undercutting surface pieces.

According to an additional embodiment of the tool according to the invention, the stop element, which limits the path of the radially yielding cladding pieces, is fixed as one piece to the base section of the die. This has the effect of simply achieving the required solidity with only one work step. According to the invention, this stop element may be adjustable or repositionable. It is crucial that this adjustability or repositionability assures a connection between the stop element and base element. Normally, the die will be replaced if the radial path is changed, for example, for a different application. A modification of the position of the stop element can be achieved with minimal effort, however. According to the invention, the base element of the die can consist of a single piece on which grooves and bores are made for the yielding cladding sections of the springs etc. This results in a compact tool that is easily installed into the machine tool.

According to an additional embodiment of the tool according to the invention, the base surface of the base element facing the work opening serves as a support and as a guide for the radial flow of the cladding pieces. This primarily avoids gaps in the base arising during the work process and related repositioning of the wall sections into which material of the compressed plate sections might intrude, whereby the desired cold-hardening would be jeopardized, and whereby several work steps would be required to create the connection point.

According to an additional embodiment of the invention, the cladding sections are radially loaded via spring force in the direction of the work opening. In a known manner, this spring force can take different forms. It can be designed as an interior leaf spring, the free end of which presses against the movable cladding pieces, whereas the other end is attached to the body of the die, or it may be in the form of radially compressing spiral springs or as an annular spring encompassing the die pieces. It is less important that the radial force influence the compression process; rather, it is more important that the movable cladding pieces be returned to their original position after removal of the workpiece. It is also conceivable that the individual leaf springs may comprise sections connecting one another, whereby these connecting sections are positionable into recesses in the die.

According to one preferable embodiment of the invention, the facing walls serving as a radial guide of a movable cladding piece are parallel to two fixed cladding sections. This ensures that a minimum of compressed material can enter into any gaps.

According to an additional preferred embodiment of the tool according to the invention, the die is embodied as a rivet, a nut, a bolt, or a similar element and remains as a lost die form or force-fit in the deep-draw opening of the plate upon completion of the joining process. This joining of material creates additional joint stability, primarily in that the deep-draw opening is filled in a form-fit manner and the connecting point can no longer become disconnected. According to another preferred embodiment of the invention, the rivet exhibits, at least on the end side, an indentation whereby the rivet material more advantageously expands when the rivet is impressed; this leads to not only greater stability, but also a better visual appearance. Since the rivet material can be harder than the plate material, there is an optimal material flow with corresponding undercutting of the plate by the compressed material.

According to this preferable embodiment according to the invention, the material of the lost punch is harder than the plate material compressed during the joining process. During the first stage of the process, namely the deep-draw procedure, there is no deformation of the punch, whereas during the subsequent radial compression procedure, for which 80 percent of the force is used, the punch material deforms in order to ensure a particularly strong form-fit. All of this occurs in a single work step.

According to an additional embodiment of the invention, there is a radial groove to receive the compressed material in order to enhance the anchoring of this lost punch in the plate or deep-draw opening.

According to an additional preferred embodiment of the invention, the punch exhibits an elevation on the end side facing the base element. This elevation causes, for example, when using a rivet, enhanced spreading of the end side and thereby improved undercutting of the point of junction.

According to an additional embodiment of the invention, an open-ring channel is provided in the front face of the base surface of the base element. By means of such a ring channel, the end side end of the lost punch can spread more fully, especially if it is in the form of a rivet, since the material to be compressed can seek a corresponding receptacle.

According to an additional preferred embodiment of the invention, there is, on the base surface of the base part, a centrally symmetrical elevation. This elevation does not exclude a ring channel positioned centrally and symmetrically thereto in the base element. This elevation forces the punch material to spread, whereby this spreading occurs generally after the deep-draw procedure.

Additional preferable embodiments of the invention can be found in the following description, drawing, and claims of the invention.

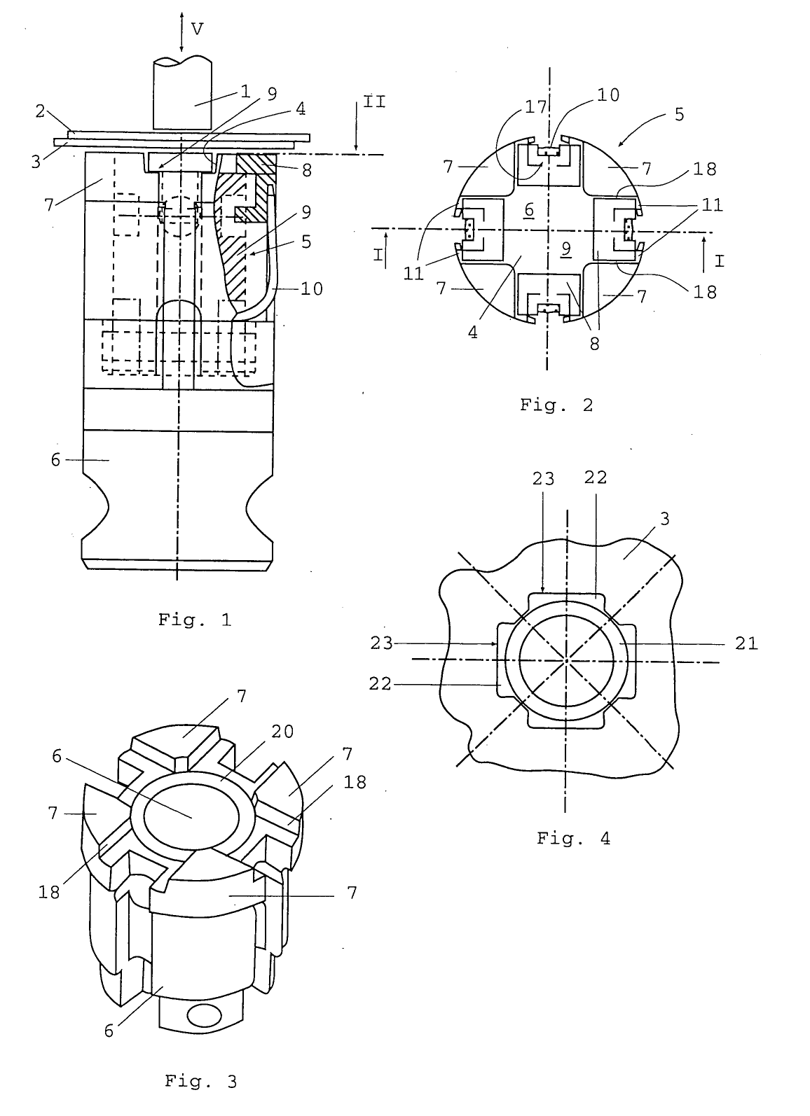

FIG. 1: A tool, according to the invention, simplified and presented in a longitudinal cross-section corresponding to section line I-I in FIG. 2.

FIG. 2: A top view of the die according to arrow II in FIG. 1.

FIG. 3: A perspective view of a variant of a base element of the die.

FIG. 4: A view of a junction created with this tool.

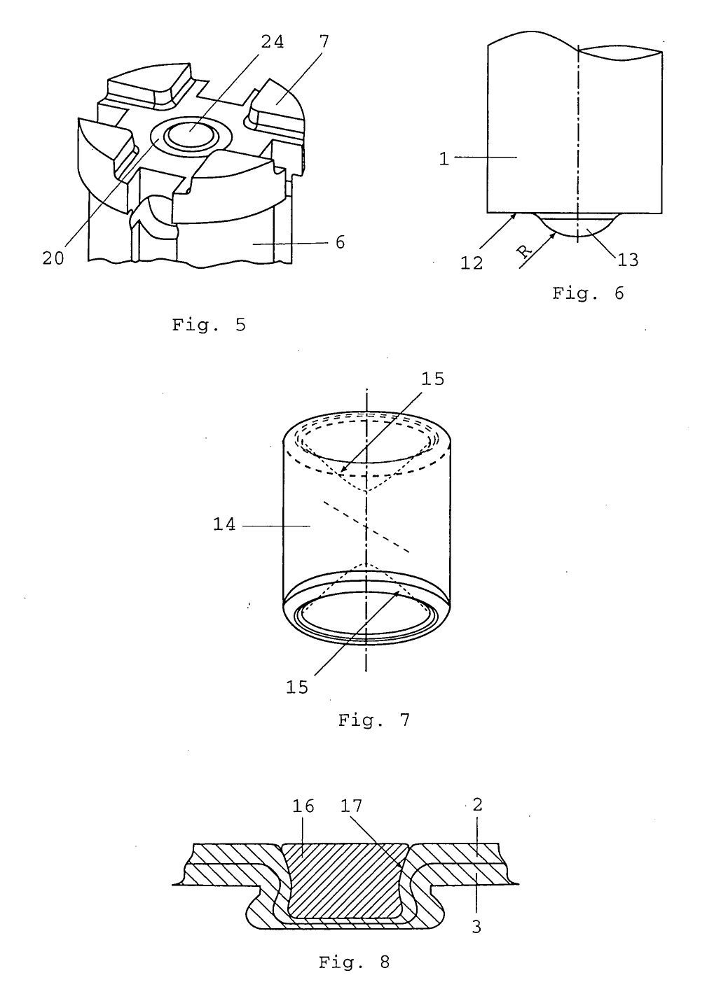

FIG. 5: A perspective view of a base element corresponding to FIG. 3 with an elevation on the base surface.

FIG. 6: A variant of the punch with a domed front face [in lateral view].

FIG. 7: A “lost punch” in perspective view with sunken end sides.

FIG. 8: A sectional cut by a tool with a “lost punch”.

### DESCRIPTION OF THE EMBODIMENT SAMPLE

FIGS. 1 and 2 depict a tool, according to the invention, without the previously known tool machine for the joining of plates or the joining of bolts, nuts, and similar elements with a plate, whereby there is no transection of the plate, but rather a deep-draw procedure with subsequent compression of the deep-drawn material.

This tool comprises, on the one hand, punch 1 driven by a tool machine, said punch being positioned above two metal plates to be joined, 2 and 3, and opposing work opening 4 of multi-part die 5. Punch 1 and die 5 are inserted in the tool machine, whereby punch 1, after insertion of metal plates 2 and 3, is actuated in the direction of double arrow V to accomplish the joint. During a downward-directed working stroke, metal plates 2 and 3 are first drawn into work opening 4 and afterward, upon increase of driving force of punch 1 on base surface 9 of work opening 4, said plates are compressed radially outward, whereby the compressed material is first deep-drawn by punch 1 and the subsequently compressed surfaces of metal plates 2 and 3 undercut the non-moving sections of metal plates 2 and 3 in a known manner, thus effecting the connection of the plates.

Instead of the portrayed method in which punch 1, after effecting the connection of plates 2 and 3, is removed again from work opening 4 corresponding to arrow V, the punch, according to the invention, can be formed as a lost punch, that is, it is positioned in front of plates 2 and 3, as well as work opening 4, then pressed into plates 2 and 3 by an extrusion ram used for the deep-draw process.

Such a lost punch may be formed as a rivet, which primarily serves to separate the deep-drawn and compressed plate section, or either it can be formed as a threaded bolt or correspondingly formed nut, which can then be used to attach other sections to a single plate. Significant for this invention is that this punch (deep-draw compression punch, lost punch in the form of a rivet, bolt, nut, or similar element) draws the plate material deeply in the first work step in order to compress said material in a radial direction.

Work opening 4 of die 5 is limited by four fixed wall sections 7 or four yielding cladding pieces 8, as well as base surface 9, on which cladding pieces 8 are radially movable between wall sections 7. Cladding pieces 8 are provided with a height corresponding to work opening 4. Cladding pieces 8 are stressed by leaf springs 10 in the direction of work opening 4. According to the invention, the path of these cladding pieces 8 is limited by stop elements 11.

This basic principle of punch and die can be embodied in different manners, whereby stop elements 11 is essential to the function according to the invention. After the deep-drawing of metal plates 2 and 3 into work opening 4 during the first stroke of punch 1, sections of these metal plates 2 and 3, which have been deep-drawn over the upper edge of work opening 4, are correspondingly reduced in thickness, that is, are drawn inwardly in a cup-like shape. After an additional stroke of die 1, deep-drawn plate material lying on base element 6 is pressed radially outward, whereby the pressed material can only flow in the direction where radially movable cladding pieces 8 are positioned. These are displaced against the spring load of leaf springs 10, which do not exert any forming forces on the pressed material, until these cladding pieces 8 run against stop elements 11. Since this pressing and compression process is not completed, the compressed material, upon significant increase of pressure, is further compressed, resulting in cold hardening of this compressed material of the plate sections, and thus leading to a stability increase of over 30 percent compared to material subjected solely to radially orthogonal compression. Since these compressed sections significantly undercut metal plates 2 and 3, which are particularly required by the yielding of cladding pieces 8, a joint with extraordinarily high stability is created. Upon retraction of punch 1 or ram and removal of the workpiece, cladding pieces 8 are pushed back into the indicated starting position by leaf springs 10 so that the process may be repeated. Since cladding pieces 8 on the side of facing punch 1 are movable on level base surface 9 of base element 6, high lifting force can be exerted upon cladding pieces 8 without negatively affecting the radial displacement. To allow a corresponding radial guide for cladding pieces 8, they face toward fixed wall sections 7 and away from parallel sides 18.

As can be particularly seen in FIGS. 3 and 4, there may be, depending upon need, other configurations in base surface 9 of the base sections not traversed by cladding pieces 8 that can lead to an improvement in the material flow or compression. Thus, for example, in FIG. 3, there is ring channel 20 in base surface 9 of base element 6, which results in improved spreading of the deep-drawn and compressed plate material, that is, the compressed material is more easily displaced. The advantage resulting from this type of engagement of the workpiece can be seen in FIG. 4, which shows from the vantage point of the die a connecting point on a section of the workpiece, with annular ring 21 relating to ring channel 20 of the die and compressed material accumulation 22, which due to the facing sides of the movable cladding pieces displays straight limiting edges 23 in contrast to annular ring 21.

As can be seen in FIG. 5, central region 24 of base surface 9 can be domed in the lifting direction, for example, to achieve an additional radial compression of the compressed plate sections. As seen in FIG. 3, ring channel 20 can be present in central region 24.

FIG. 6 illustrates a variant of punch 1 in a lateral view, in which on end side 12 there is elevation 13 that forces the plate material during compression radially outward, whereby this results in a thinning of the base of the connection point. This also facilitates the spreading of the material during the compression process.

FIG. 7 and 8 show the use of the “lost punch”, which as described above is used after insertion into the tool using an extrusion die relating to the tool. This “lost punch” primarily prevents a separation of the joint.

FIG. 7 illustrates a “lost punch” in the form of rivet 14, in which both end sides 15 are indented conically inwardly. This cone-shaped formation causes the material to separate, particularly during the compression process, whereby the undercutting of the non-moving material is strengthened by the deep-drawn and compressed material. As a result of the hardening of the material, according to the invention, this effect is enhanced by the additional compression forces.

FIG. 8 illustrates a section in which said lost punch 16 is embedded in plates 2 and 3 after the stamping and deep-drawing process. Cup 17, caused by rivet 16 in plates 2 and 3, exhibits a tapering in its center that forms an extremely solid joint between plates 2 and 3 as a result of inserted lost punch 16. The free end side of this lost punch 16 lies along the plane of the exterior surface of plate 2.

All characteristics contained in the description, the following claims, and drawings may be essential to the invention, both as individual entities as well as in combination with other described characteristics.

### NUMBERED REFERENCES

1 Punch
2,3 Metal plate
4 Work opening
5 Die
6 Base element
7 Fixed wall sections
8 Cladding pieces, movable
9 Base surface
10 Leaf spring
11 Stop element
12 End side of 1
13 Elevation
14 Rivet
15 End side
16 Lost punch
17 Tapering
18 Sides of 8
20 Ring channel
21 Annular ring
22 Material accumulation
23 Limiting edges
24 Central region

1. Procedure for pressed joint connections of components with at least one plate,
in which a punch passing through a die opening of the base element of a die
first, without transecting, the plate clinches it, and
then, this deep-drawn plate material compresses, under plastic deformation of said material, between the punch and base surface of the die perpendicular to the axial direction, and counter to the force of elastically yielding wall sections of the die,
then, this deep-drawn plate material compresses, under plastic deformation of said material, between the punch and base surface of the die, perpendicular to the axial direction, and counter to the force of the elastically yielding wall sections of the die,
whereby this radially compressed plate material, in order to create a connection, undercuts the non-deep-drawn areas of the plate,
wherein
between the yielding wall sections of the die opening there are wall sections securely attached to the base element of the die and
the yielding wall sections are displaceable to a surface running parallel to the displacement direction and pass uninterrupted to the base surface.

2. Method, in particular, according to claim 1,
wherein
the radial path of the yielding wall sections,
is rigidly limited to achieve a seal and consequent hardening of the compressed and crushed material,
upon traversing a predetermined distance.

3. Method, according to claim 1, wherein the limit of the radial path, viewed across the perimeter of the die, is variously modifiable, or varies in size such that various hardnesses can be achieved during cold forming.

4. Method according to claim 1, wherein the punch at least that part inserted into the die opening remains as a “lost punch” in that the section inserted in the die opening remains in the insertion opening in a rivet-like and form-fit manner.

5. Tool with punch and die for pressed joint connection or similar for the joining of components with at least one plate,
with a work opening (die opening) in the multi-part die,
with a plurality of outwardly yielding cladding sections (wall sections) arranged radially around the work opening of the die,
with a base surface of the die positioned opposite the end side of the punch, axially adjacent to the work opening,
which is provided on a base element,
for the performance of the method according to claim 1,
wherein
along the perimeter of the work opening, between the cladding pieces, several cladding sections (7) are unyieldingly connected to the base element (one-piece), and that these cladding sections serve as radial guides for the yielding cladding pieces.

6. Tool, according to claim 5, wherein the radial path of the cladding pieces is limited (during the joining process of the die) by a fixed stop element.

7. Tool, according to claim 5, wherein the stop element limiting the radial path is fixed (one-piece) to the base piece of the die.

8. Tool, according to claim 5, with a base surface of the base element facing the work opening functioning as support and radial guide for the cladding pieces.

9. Tool, according to claim 5, wherein the cladding pieces are stressed radially in the direction of the work opening by a spring load.

10. Tool, according to claim 9, wherein the facing walls forming the radial guide of a moveable cladding piece comprise two cladding sections parallel to one another.

11. Tool, according to claim 5, wherein the punch is a lost punch in the form of a rivet, nut, bolt, or similar element, designed to remain in place upon completion of the joining, in either a form-fit or a force-fit manner in the deep-draw opening it created in the plate.

12. Tool, in particular, according to claim 11, wherein the rivet features an indentation on at least one of its end sides.

13. Tool, according to claim 11, wherein the material of the lost punch is harder than the plate material compressed during the joining process.

14. Tool, according to claim 11, wherein in the radial cladding surface of the lost punch a radial groove is provided for receiving the compressed material.

15. Tool, according to claim 11, wherein the punch exhibits an elevation on the base surface facing the end side.

16. Tool, according claim 5, wherein an open circular channel is located on the end side of the base surface of the base piece.

17. Tool, according to claim 5, wherein a central, symmetrical elevation is located on the base surface of the base piece.
